(19) United States
(12) Patent Application Publication
(10) Pub. No.: US 2001/0013123 A1
(43) Pub. Date: Aug. 9, 2001

(54) Customized program creation by splicing server based video, audio, or graphical segments

(76) Inventors: Michael J. Freeman, Kings Point, NY (US); Gregory W. Harper, New York, NY (US); Kevin M. Liga, Port Chester, NY (US); Frank P. Deo, Kendall Park, NJ (US)

Correspondence Address: DORSEY & WHITNEY, LLP, SUITE 4700, 370 SEVENTEENTH STREET, DENVER, CO, 80202-5647, US

(21) Appl. No.: 09/767,053

(22) Filed: Jan. 22, 2001

Related U.S. Application Data
(63) Continuation-in-part of application No. 09/335,372, filed on Jun. 17, 1999.
Application No. 09/335,372 is a continuation-in-part of application No. 09/154,069, filed on Sep. 16, 1998.
Application No. 09/154,069 is a continuation-in-part of application No. 08/887,314, filed on Jul. 3, 1997, now Pat. No. 6,181,334.
Application No. 08/887,314 is a continuation of application No. 08/443,607, filed on May 18, 1995, now Pat. No. 5,724,091.
Application No. 08/443,607 is a continuation-in-part of application No. 08/166,608, filed on Dec. 13, 1993, now abandoned.
Application No. 08/166,608 is a continuation of application No. 07/797,298, filed on Nov. 25, 1991, now abandoned.

(51) Int. Cl. H04N 7/025; H04N 7/10

(52) U.S. Cl. 725/34

(57) ABSTRACT

A Customized Programming creation system provides the ability to transmit Customized Programming offerings to individual users based upon their known profile or their responses to contemporaneous queries. In its basic form, the invention provides for a programming transmission center to maintain a single or multiple MPEG storage server environments. Through the use of digital conversion and MPEG compression standards, a vast library of programming and other information signals can be stored on such file servers. The transmission center selects and accesses programming segments or other information from the storage servers. Through the use of splice points encoded through the MPEG process, the programming transmission center can inconspicuously splice disparate program segments together to create a single custom program stream for delivery to a single user or multiple users of the same profile.

Using interactive programming technology, a user profile is created and stored based on known, purchased and/or usage-based variables. The interactive programming system collects information through the user's receiver by monitoring the user's viewing habits and cataloguing user responses to interactive programming queries. Such profile information is transmitted to the programming transmission center via a backchannel communication link with the user's receiver. The Customized Programming stream may then be created to reinforce known or educated assumptions of programming and commercial selections that are most pertinent to the particular user, bringing some personalization to the vast library of stored programs and information.

### CROSS REFERENCES TO RELATED APPLICATIONS

This application is a continuation-in-part of and claims priority to U.S. patent application Ser. No. 09/335,372, which is a continuation-in-part of U.S. patent application Ser. No. 09/154,069, which is a continuation-in-part of U.S. patent application Ser. No. 08/887,314, which is a continuation of U.S. patent application Ser. No. 08/443,607, now U.S. Pat. No. 5,724,091.

### BACKGROUND OF THE INVENTION

1. Field of the Invention

This invention relates generally to the provision of programming content via digital television signals to viewers. This invention further relates to the automated selection of particular programming content based upon accumulated personal profiles for individual viewers.

2. Description of Related Art

Digital transmission and compression technologies are pushing the envelope of the available bandwidth for transmitting programming to users. Cable and satellite television subscribers are now able to receive over 100 channels, and the fulfillment of the promise of hundreds more channels of programming is on the horizon. While many have expressed dismay that there is nothing worthwhile to watch on television, the new concern of television viewers may now be: “How do I find programming of interest to me?” With hundreds of channels to choose from, programming selection will become exceedingly difficult. Furthermore, this proliferation of channels still will not guarantee that the programming a particular viewer wants to see will be presented at a time convenient to the viewer's schedule.

In other developments, cable and satellite television broadcasters are currently able to offer customers the ability to receive limited selections of programming outside of the normal broadcast schedule offerings. Similar opportunities are available in closed circuit audio/video networks, most notably in the hotel industry. Such technology is generally known by the moniker “video on demand.” This individualized programming selection has also been made possible through the advent of digital television broadcasting, related digital compression technologies, and storage media such as digital video disks and digital file servers. Remote or headend based MPEG storage/playback systems can now have a one to one relationship with the viewer, however, the programming selection is still limited and there also the requirement of searching through a listing of program offerings to find a program to watch. Interactive television technology, is allowing viewers to actively participate in the programming rather than passively watch it. However, even this technology is presently limited to use with programs that have been specially encoded for interactivity and are only available as part of a set viewing schedule.

In addition to the concerns of and limitations on the viewers, the channel explosion also makes it more difficult for advertisers to reach, or even find viewers potentially interested in their products or services. Viewers will be scattered throughout an ever spread of channels and the advertisers resources will be spread thin. Viewers will also be more likely to flip or surf through the spectrum of program offerings, searching for something of interest. When programming does not hold interest to a viewer, the advertiser loses because the viewer will not continue to view watch the channel during a commercial break in anticipation of the next segment of the program.

There is a need, therefore, to for a methodology or system to cut through the overload of programming channels and give the viewer programming that he or she is interested in, without the viewer having to search through innumerable channels to find it. It would be even better if the programming choices of interest to a viewer could be presented at the time a viewer wants to watch it. Such a system would be a blessing for advertisers, because the viewer would be interested in the programming and would likely watch any commercials placed between program segments because of the strong desire to continue to watch the programming. In the best of all worlds, the advertiser would be able to pick the profile of viewers to receive its ads. If this were possible, it is even more likely that the viewer would watch the commercials between program segments because the products and services advertised would likely be of interest to the viewer as well.

### SUMMARY OF THE INVENTION

This invention contemplates a method and system of providing customized programming in a digital interactive programming system. The customize programming is preferably transmitted from a programming transmission center to the receiver of at least one user. The customized programming comprises a succession of digital program segments selected by the interactive programming system from a plurality of digital program segments according to user preference information of the user. The customized programming is selected to appeal to the programming preferences of the user.

The method preferably includes the following steps: accessing user preference information indicating the programming preferences of the user; selecting and accessing a first digital program segment of the succession of digital program segments from the plurality of digital programming segments according to the user preference information of the user; transmitting the first digital program segment to a reception system of the user; identifying a splice point in the first digital program segment before the completing the step of transmission; selecting and accessing a second digital program segment of the succession of digital program segments from the plurality of digital program segments according to the user preference information; seamlessly switching from the first digital program segment to the second digital program segment at the splice point identified in the first digital program segment, wherein the switch occurs without creating any artifacts perceptible when the succession of digital program segments is presented to the user; and transmitting the second program segment to the reception system of the user.

This invention contemplates taking the concept of individualized programming beyond the viewer merely being able to choose a convenient time to watch available, stored programming. This invention offers the ability to splice together multiple, and perhaps disparate, programming elements to offer customized, programming to a particular user or multiple users of a similar profile. The present invention offers the advantage of providing programming and advertising targeted to the interests of the user. Targeting individual user interests may result in increased satisfaction with the programming which may ultimately lead to increased usage of the offerings of such an inventive system and increased effectiveness of associated advertising.

The customized programming creation system of the present invention provides the ability to transmit customized programming offerings to individual users based upon their known profile or their responses to queries. In its basic form, the invention provides for a programming transmission center to maintain a single or multiple MPEG storage server environments. Through the use of digital conversion and MPEG compression standards, or other similar compression techniques, a vast library of programming and other information signals can be stored on such file servers, consuming far less space than the original analog or even uncompressed digital signals.

In a customized programming creation system, the programming transmission center selects and accesses programming segments or other information from the storage servers. Through the use of splice points encoded into the compressed programming files during the MPEG compression process, the programming transmission center can inconspicuously splice disparate program segments together to create a single, custom program stream for delivery to a single user, or multiple users of the same profile.

Using interactive programming technology, a user profile is created and stored based on known, purchased, and/or usage-based variables. The interactive programming system collects information through the user's receiver by monitoring the user's viewing habits and cataloguing user responses to interactive programming queries. Such profile information is preferably transmitted to the programming transmission center via a backchannel communication link with the user's receiver. The customized programming stream may then be created by following known or educated assumptions of programming and commercial selections that are most pertinent to the particular user, bringing some personalization to the vast library of stored programs and information.

Examples of customized programming available through this inventive system are many and varied. Consider a user who may want customized programming of local information each morning while preparing for the day. The customized programming system could, for example, select a weather segment based upon the user's geographic location, a traffic report by comparing the user's home address to the location of the user's place of business, school events or weather closures if information about the user's children is known in the user profile, and perhaps information about upcoming community events or public meetings of potential interest to the user.

Customized programming could also consist of an on-demand highlight show of program selections based on the user's profile and/or interests. For example, a user who is a baseball fan may desire to see his favorite baseball player's performance of that day. The customized programming system could provide segments of all the at-bats and any significant defensive plays of the desired player indicated by the user. Advertising of likely interest to the user, tailored by the user profile, could also be interspersed between program segments. In the case of the baseball fan, ads for sports magazines may be appropriate selections.

As another example, consider a user who is an outdoor or recreational activity enthusiast. This user may be provided program segments by the customized programming system with regular updates about new equipment on the market. Alternatively, a travel enthusiast planning a trip to Europe may be provided multiple travel programs on European travel to view or choose between. In another instance, programming could be compiled by the customized program system to present a homeowner “This Old House” and “Hometime” episodes that have dealt with a specific repair job. Further, a customized programming session could be extended indefinitely by the customized programming system, providing suggestions of other programming of potential interest to the user based upon the user profile or the subject matter of a previously viewed program.

The potential advantages to such a customized programming creation system are enormous. Users receive programming which is specific to their needs and interests at a time that is convenient to them, rather than flipping through the over-abundance of television channels with unappealing programming. Advertisers too can reach consumers more cost effectively by targeting advertisements to only those users whose interests and profile closely match the product or service being offered. This is a benefit for the user as well, who is more likely to receive only advertising which is of interest to him or her. This invention can further be implemented in other programming systems beyond television broadcasting, for example, radio broadcasting, computer networks, Internet and web casting, telephone networks, and personal communication networks such as for use with wireless telephones, personal digital assistants (“PDAs”), and web phones.

### BRIEF DESCRIPTION OF THE DRAWINGS

FIG. 1a is a diagram depicting a preferred embodiment of the various components of the present inventive system and their interaction.

FIG. 1b is a diagram depicting a preferred embodiment of the various components of the present invention and their interaction in an Internet transmission system environment.

FIG. 2a is a block diagram of the preferred components of an encoding and compression system for storing programming on storage servers.

FIG. 2b is a block diagram of the preferred components of an interactive programming transmission system used to transmit customized programming to a user's reception system, of which a preferred embodiment is shown in FIG. 5.

FIG. 3 is a representation of a sequence of digital packets used to effect a seamless switching process between digital video signals.

FIG. 4 is a representation of a switching process between digital audio signals.

FIG. 5 is a block diagram of the components of an interactive programming receiver used to achieve the benefits of the present invention.

### DETAILED DESCRIPTION OF THE INVENTION

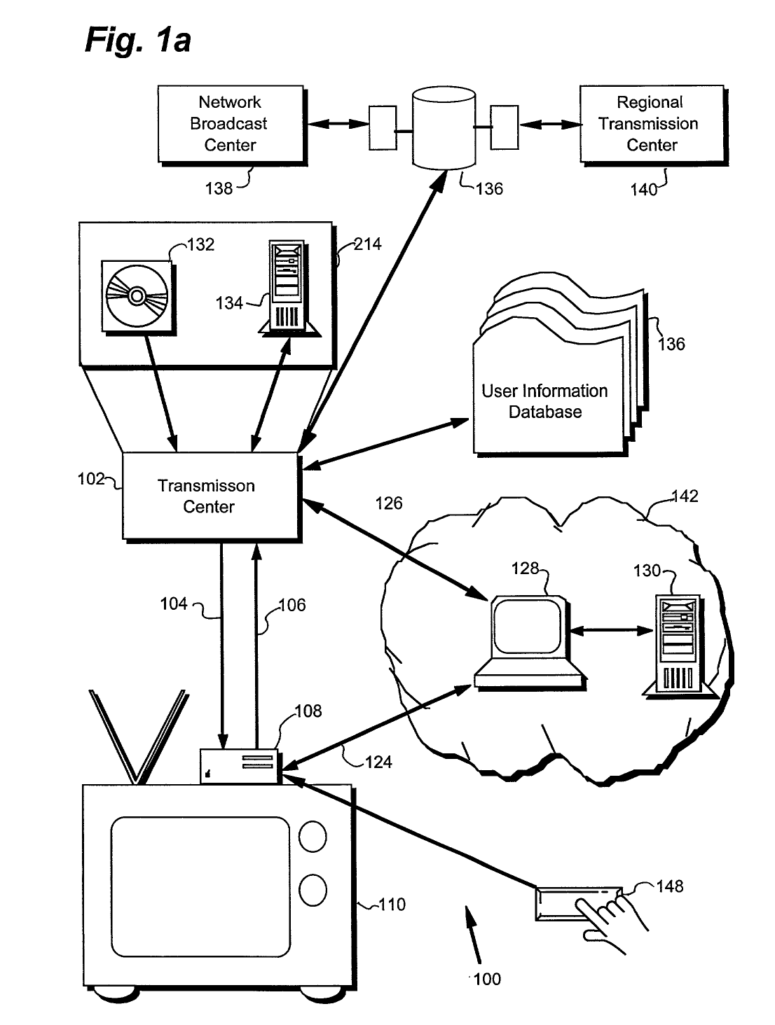

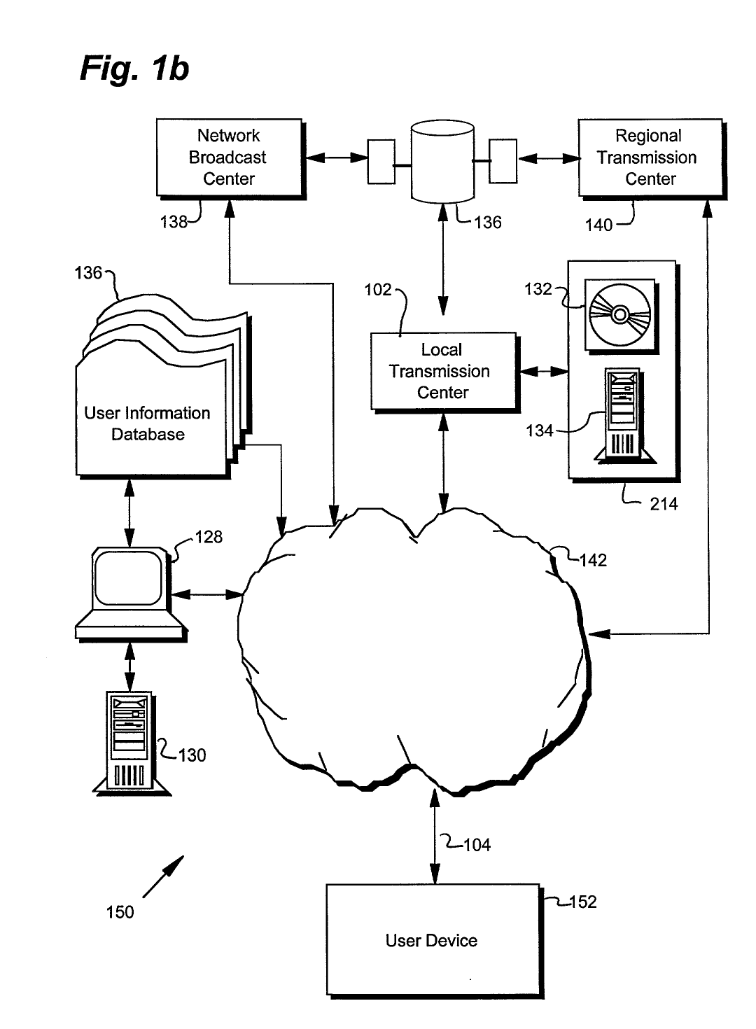

In order to achieve the benefits of customized programming creation system, the present invention employs a digital interactive programming system as disclosed in U.S. Pat. No. 5,724,091, and U.S. patent application Ser. Nos. 08/887,314, 09/154,069, and 09/335,372, each of which is entitled: “Compressed Digital Data Seamless Video Switching System,” and which are incorporated herein by reference. A preferred embodiment of a digital interactive programming system 100 specific to customized programming creation is shown in FIG. 1a. FIG. 1b depicts an interactive programming system 150 that utilizes an entirely network based transmission system, preferably the Internet 142.

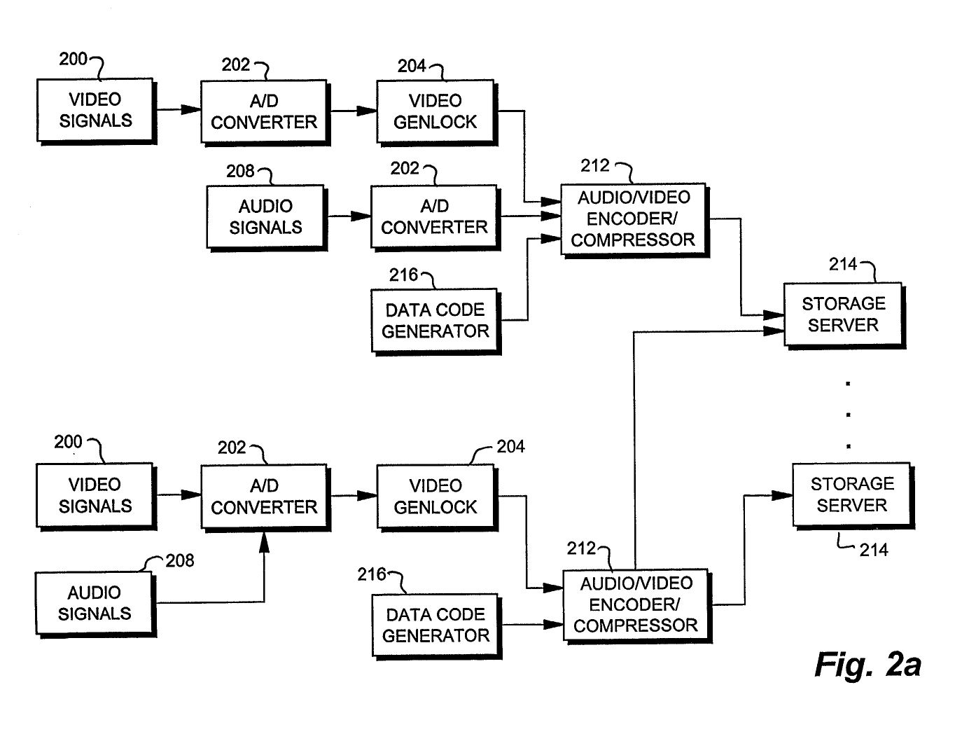

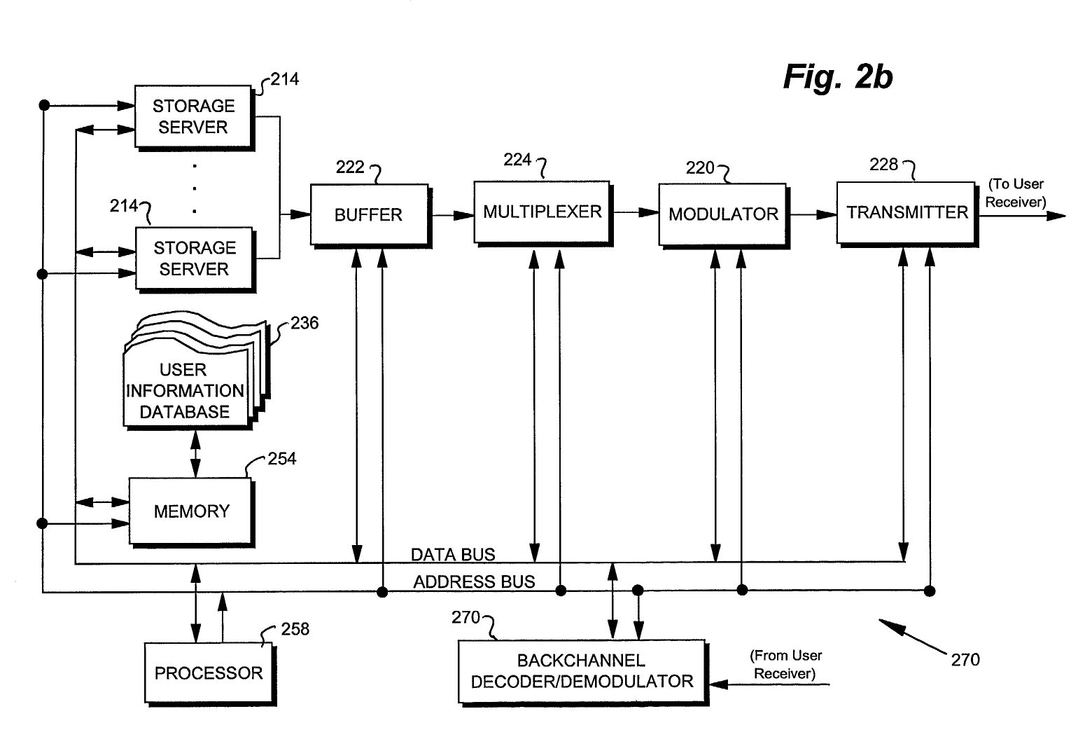

In a customized programming creation system, the purpose is to provide one or more users, on an individual basis, programming calculated to be of particular interest to each user. The transmission center 102 in FIG. 1a provides a user at a reception site tailored programming based upon user preference information. Programming available for customized delivery to a user is preferably stored in a library of storage servers 214 in the transmission center 102. Storage servers 214 (see also FIGS. 2a and 2b) may be computer servers 134 with large data storage capacity and very fast file seek time for storing MPEG programming files or other files formatted in similar industry standard video and audio compression schemes. Storage servers 214 may alternately or additionally consist of programming files stored on optical media such as digital video disk 132 racks or other compact disk formats. Less preferable, although still functional, is program storage on video tape, audio tape, and other tape storage mechanisms. Such programming needs to proceed through the MPEG or other encoding process before transmission.

There may likely be a limit to the capacity of storage servers 214 at any given transmission center 102 due to the sheer volume of programming transmitted to users each day. Further, it would be a poor use of resources to store every program ever transmitted from a particular transmission center 102, especially when some programming may be of very low interest with minimal numbers of users receiving programming from a particular transmission center 102, while other programming may be of high interest to significant numbers of users. This high interest programming is likely to receive storage preference in the storage servers 214 at the local transmission center 102. In the event that a user is interested in a segment for a customized programming session that is not stored at the local transmission center 102, a retransmission request may be made to another local transmission center in a different region or to a regional transmission center 140, for a search of their libraries, or even to an original programming source such as a local or national broadcast center 138. If any of these broadcast or transmission center sources has the desired programming in their library, the programming can be uplinked to satellite 136 and then downlinked to transmission center 102 for use in the creation of the customized programming for the user.

Programming segments for use in a customized programming presentation may be additionally accessed by the transmission center 102 over a communication network 142, preferably the Internet, via a communication link 126. The transmission center 102 can access programming segments from a remote file server 130 preferably through any standard file transfer interface or protocol 128, for example a World Wide Web interface. Programming content could be transferred over the communication network 142 to the transmission center 102 for transmission to the user, or the programming content could be pushed to the user over the communication network 142 directly from the remote file server 130 via communication link 124.

Customized programming content is transmitted to the user from the transmission center 102 to a receiver 108 at a user's reception site over a data transport stream 104. The data transport stream 104 may be carried over any conventional digital transmission medium including broadcast television, cable television or other coaxial system, satellite, direct broadcast satellite (“DBS”), fiber optic, microwave (e.g., a multi-point multi-channel distribution system (“MMDS”)), radio, telephony, wireless telephony, digital subscriber line (“DSL”), personal communication system (“PCS”) networks, the Internet, public networks, and private networks, or any other transmission means. Receiver 108 is preferably connected to a presentation device 110—a television in the preferred embodiment. However, the presentation device 110 may be, for example, a personal computer, a radio, a video game console, a telephony device, a wireless device, a web pad, and a personal digital assistant (“PDA”). Receiver 108 may be a stand-alone unit such as a cable or satellite television set-top box, or it may comprise additional hardware and software components within a television or other presentation device, a video game console, a personal computer system, or a PDA.

User preference information is generally collected at the receiver 108, generally through user input via a user interface device 148. The user interface device 148 is preferably a radio frequency or infrared remote control device, but could be a keyboard, a touch screen, or even a voice activated control interface. User preference information may also be collected and analyzed based upon user programming selections, such as through an event programming guide, and other viewing habits of the user. The user preference information is preferably transmitted to the transmission center 102 via a backchannel communication link 106. The user preference information is preferably stored in a user information database 136 at the transmission center 102. The user preference information may additionally be stored in the receiver 108 at the user's reception site, or in a user information database 136 that is physically remote from the transmission center 102 or receiver 108, but connected to one or both via a communication link or network.

In another embodiment, depicted in FIG. 1b, the interactive programming transmission system 150 provides the customized programming over a network communication system. Rather than broadcasting the customized programming, the transmission center 102 is connected to a communication network 142 and the program segments are transmitted to the user device 152 via an information transfer protocol, for example, by streaming the program segments. In addition to the transmission center 102, the regional transmission centers 140 and network broadcast centers 138 may similarly be connected to the communication network 142 and provide customized programming segments directly to the user device 152, for example by streaming the programming components to the user device, bypassing the local transmission center 102. Additional content may be available for access over the communication network 142 such as user preference information in a user information database 136 or on a remote file server 130 via a file transfer interface 128, for example a World Wide Web site. The user device 152 can be, for example, a PDA, a web pad, a wireless telephone, a wired telephony device, an Internet enabled telephone, a personal computer, a radio, and a portable television. The transmission medium may be, for example, a direct Internet connection, a wireless Internet connection, and a microwave transmission.

Customized programming content presented via a digital interactive programming system 100 system can be provided in multiple forms. It can be simulated, wherein all possible programming content made available for customized programming is transmitted at all times so that switching between alternative programming segments to select tailored programming content can be performed at each user's receiver 108. This is a very limiting embodiment because the quantity of alternative programming segments available is limited as a function of the bandwidth of the transport stream 104. A second embodiment may transmit certain programming content to various groups of users based upon constructed group profiles. This embodiment provides more targeted programming content transmitted to a user's receiver 108 within the bandwidth limitations and allows for additional customization through switching between alternative programming segments at the user's receiver 108. A preferred embodiment provides for complete customized programming, tailored to each user, and is preferably implemented by switching between programming segments at the transmission center 102 prior to transmission, rather than at a user's receiver 108.

The ability to seamlessly switch between digital programming signals, whether representing independent programming segments or alternative, related programming segments within one interactive program, is highly preferred in the customized programming creation system. The term “programming segments,” as used herein, preferably refers to any cohesive set of programming content. Examples of sets of such programming content include a television program, a film, a song, a commercial, a music video, and a story in a newscast. However, programming segments could be shorter clips or “bites” of programming content if that is what is desired for presentation. “Seamless switching” is defined as switching between programming segments in a transport stream 104 that does not produce user perceptible artifacts. The process of encoding the programming content at the transmission center 102 is the key to a simple yet effective seamless switch. This process shall be discussed with reference to FIGS. 2a, 2b, 3, and 4.

In a digital interactive programming system 100, such as used for customized programming creation, a plurality of video signals 200, or other programming signals constituting programming components for a plurality of customized programming presentations, is simultaneously transmitted to a plurality of users. Other programming signals, in lieu of or in addition to video signals 200 may include, for example audio signals 208, graphic signals, text signals, still frame image signals, multimedia, streaming video, animation, and executable object or application code, which are collectively referred to herein as “programming signals.” Video signals 200, or other programming signals, may be any signals suitable for interactive conversation, such as those described in U.S. Pat. Nos. 3,947,972; 4,264,924; 4,264,925; 4,602,279; or 4,847,700 for example. Various types of time and content related video, audio, graphic, and other programming signals exist that are suitable for interactive operation.

Customized programming according to the present invention is preferably delivered to the transmission center 102, such as a cable, satellite, or other distribution network, in pre-digitized and/or precompressed format. As seen in FIG. 2a, video signals 200, or other programming signals, are directed to analog-to-digital (“A/D”) converters 202 preferably as part of the operations of the transmission center 102. The origin of the video signals 200 could be, for example, from video servers, video tape decks, digital video disks (“DVD”), satellite feed, and cameras for live video. Some of the video signals 200 which comprise the programming components may already be in digital form such as Motion Pictures Experts Group (“MPEG”) standards, high definition television (“HDTV”), or European phase alternate line (“PAL”) standards, and therefore may bypass the A/D converters 202. Audio signals 208, which may be counterparts to the video signals 200, or which may originate from compact digital disks (“CD”), magnetic tapes, microphones, or other audio recording media, are also directed to A/D converters 202, if accompanying audio from such sources is necessary or desired and the audio signals 208 are not already in digital form. Preferably, the audio signals 208 are digitized using the Dolby® AC-3 format; however, any conventional audio A/D encoding scheme is acceptable.

As is well known in the art, the A/D converters 202 convert the various video signals 200, audio signals 208, or other programming signals into digital format. AID converters 202 may be of any conventional type for converting analog signals to digital format. Individual A/D converters 202 may not be needed for each type of programming signal, but rather fewer A/D converters 202, or even a single A/D converter 202, are capable of digitizing various types of programming signals including video signals 200 and audio signals 208. The plurality of video signals 200 is further genlocked in a video genlock device 204, thereby time synchronizing various video programming segments.

Data code generator 216 in FIG. 2a creates data codes, which among other information preferably includes commands for controlling the interactive programming system 100 processing of customized programming used by the transmission center 102 and receivers 108, updates of system software for the receiver 108, or direct address data for making certain programming available to the user (e.g., pay-per-view events). Preferably, the data codes originating in the data code generator 216 are part of an interactive scripting language, such as ACTV® Coding Language, Educational Command Set, Version 1.1, and ACTV® Coding Language, Entertainment Command Extensions, Version 2.0, both of which are incorporated herein by reference. These data codes facilitate the multiple interactive programming options, including the customized programming segment selections, and the seamless switching between programming segments, at either the transmission center 102 or user receivers 108. The data codes provide the information necessary to link together the different customized programming segments including between the different types of programming signals, based upon user response or selection, or user preference information.

The digitized, time synchronized programming signals and data codes are then directed into the audio/video encoder/compressor (hereinafter “encoder”) 212. Compression of the various programming signals is normally performed to allow a plurality of signals to be transmitted over a single NTSC transmission channel. Preferably, the encoder 212 uses a standard MPEG-2 compression format. However, MPEG-1 and other compression formats, such as wavelets and fractals, could be utilized for compression. These techniques are compatible with the existing Advanced Television System Committee of America (“ATSC”) and digital video broadcasting (“DVB”) standards for digital video systems. With respect to the customized programming creation system of the present invention, compression by the encoder 212 additionally provides the ability to store a greater volume of programming on storage servers 214. In may be desirable in some instances to additionally have a transcoder component as part of transmission system 250. For example, if program segment content is accessed from foreign broadcasting sources, it may be in an incompatible format (e.g., DVB) and need to be transcoded to ATSC format before it could be transmitted for reception in the U.S.

As with other programming in a digital interactive programming system 100, if multiple encoders 212 are used to compress programming segments for use in the customized programming system, the encoders 212 are preferably synchronized to the same video clock. This synchronized start ensures that splice points placed in the MPEG data packets indicate switches between programming segments, particularly from or to video signals 200, so that the switches occur at the correct video frame number. SMPTE time code or vertical time code information can be used to synchronize the encoders 212. This level of synchronization is achievable within the syntax of the MPEG-2 specifications. Such synchronization provides programming producers with the ability to plan video switch occurrences between separately encoded programming segments.

All of the digitized programming signals-including the video signals 200, audio signals 208, and data codes-constituting the customized programming segments are packetized and interleaved in the encoder 212, preferably according to MPEG specifications. The standard MPEG compression and encoding process assigns packet identification numbers (“PID”s) to each data packet created. Among other information, the PID identifies the type of programming signal in the packet (e.g., audio, video, and data) so that upon reception at a receiver 108 the packet can be directed by a demultiplexer/decoder to an appropriate digital-to-analog (“D/A”) converter. PID numbers may be obtained from the MPEG-2 transport table.

MPEG encoding also incorporates a segment in each data packet called the adaptation field which carries information to direct the reconstruction of the video signal 200. The program clock reference (“PCR”) is a portion of the adaptation field which stores the frame rate of an incoming video signal 200, clocked prior to compression. This is necessary to ensure that a demultiplexer/decoder in a receiver 108 can output the decoded video signal 200 for presentation at the same rate as it was input for encoding to avoid dropping or repeating frames. Additional embedded information in the MPEG stream normally includes a presentation time stamp and a display time stamp. These time stamps are used to maintain lip synchronization between the video and audio, and also to inform the receiver 108 when to present the video and audio to the presentation device 110.

Once the various programming signals are encoded and compressed by encoder 212, they are preferably output for storage in storage servers 214. Storage servers 214 are preferably located at a transmission center 102, but as previously noted, they may be in other physical locations within the digital interactive programming system 100 for ready access of programming components. When a user requests a customized programming presentation, or when the interactive programming system 100 determines that it is appropriate to transmit a customized programming segment, the stored programming signals comprising the desired programming segment are accessed from the storage servers 214 and are further processed for transmission by a transmission system 250, shown in FIG. 2b, at the transmission center 102.

After the various digitized programming signals are selected from the storage servers 214, they are further rate controlled for transmission by the buffer 222. The buffer 222 controls the rate of transmission of the data packets to the receiver 108 so that it does not overflow or under-fill while processing. The physical buffer size of the buffer 222 is defined by the MPEG standard. Enough time must be allowed at the onset of the transmission process to fill up the buffer 222 with the compressed data to ensure data availability for an even transmission rate.

The multiplexer 224 then combines the encoded and compressed programming signals comprising the customized programming segments as they are output from the buffer 222 with other programming signals and data to create a data stream for transmission within an NTSC channel or other transmission medium. By multiplexing a plurality of disparate signals, the number of data streams to be carried by the transport stream 104 is reduced. The multiplexed data streams are then modulated for transmission by modulator 220. The modulator 220 may utilize one of several different possible modulation schemes. Preferably, 64-QAM (quadrature amplitude modulation) is chosen as the modulation scheme; however, any other conventional modulation scheme such as FSK (frequency shift keying), n-PSK (phase shift keying), and VSB (vestigial side band), can be used. With 64-QAM, the data rate at the output of the modulator 220 is around 29.26 Mbps. Examples of other modulation schemes that can be used with the present invention, with respective approximate data rates, include: 256-QAM (40 Mbps); 64 QAM PAL (42 Mbps); 256 QAM PAL (56 Mbps); and 8 VSB (19.3 Mbps).

For transmission over telephony systems, the compressed and encoded programming signals are preferably output in Digital Signal 3 (DS-3) format, Digital High-Speed Expansion Interface (DHEI) format, or any other conventional format. In some transmission systems, for example fiber optic, these RF modulation schemes are unnecessary as the transmission is purely digital. Further, the programming signals can also be formatted in Internet protocol, or other network protocol, and streamed over the Internet or other communication network to users' receivers 108.

Once modulated, the transport stream 104 is output to the transmitter 228 for transmission, preferably over one of the many NTSC channels available for broadcast. The transmitter 228 may transmit the data transport stream 104 over any conventional medium for transmitting digital data signals including, but not limited to, broadcast television, cable television, satellite, DBS, fiber optic, microwave, radio, telephony, wireless telephony, DSL, PCS networks, the Internet, public networks, and private networks, or any other transmission means. Transmission over communication networks may be accomplished by using any known protocols, for example, RTP, UDP, TCP/IP, and ATM. The transmission system may also be a telephony system transmitting a digital data stream. Thus, a multiplexed data stream containing several channels including the customized programming content may be sent directly to a user receiver 108 over a telephone line. The aforementioned digital transmission systems may include and utilize systems that transmit analog signals as well. It should be appreciated that various systems, mediums, protocols, and wave forms may be utilized in conjunction with the systems and methodologies of the present invention. In the preferred embodiment, the data stream 104 is distributed to remote user sites via cable, DBS, or other addressable transmission mediums.

In narrow bandwidth transmission systems, for example in cellular/wireless telephony or PCS networks, still frame pictures or graphics, for example compressed in JPEG format, may comprise the customized programming as opposed to moving video or other signals requiring greater bandwidth. Such still pictures or graphics could be presented on communications devices such as personal digital assistants (e.g., Palm Pilot®), telephones, wireless telephones, telephony devices for the deaf, or other devices with a liquid crystal display (LCD) or similar lower resolution display. Textual information or an audio message could accompany the still frame images. Similarly, all-audio customized programming content could be provided via a radio transmission system.

A processor 258 preferably coordinates and controls the functions of the storage servers 214 and transmission components such as the multiplexer 224, modulator 220, and the transmitter 228. The processor 258 can direct the selection and transmission of particular programming segments based upon system software stored in memory 254, preferably ROM, or from data codes stored with programming segments in the storage servers 214. A user information database 236 that collects and stores user preference information for customizing the programming segments selections may be a part of the memory 254, or it may be a separate but integrated system as indicated in FIG. 1a. A backchannel decoder/demodulator 270 receives user preference information, including interactive user inputs, viewing habits, and general information about a user from a connected user's receiver 108. This connection may be via telephony, two-way cable, the Internet, digital subscriber line, or other indirect or direct communication link.

As is well known, a standard MPEG data stream contains different types of encoded frames. There are I-frames (intra-coded), P-frames (predicated) and B-frames (bi-directionally predicated). A standard MPEG structure is known as a “group of pictures” (“GOP”). GOPs usually start with I-frames and can end with either P- or B-frames. I-frames consist of the initial, detailed picture information to recreate a video frame. The P- and B-frames consist of instructions for changes to the picture constructed from the I-frame. P-frames may include vectors which point to the I-frame, other P- or B-frames within the GOP, or a combination, to indicate changes to the picture for that frame. B-frames may similarly point to the I-frame, other P- or B-frames from the same GOP, frames from other GOPs, or a combination. The vector pointers are part of the MPEG scheme used to reduce duplication in the transmitted data resulting in the compression effects. GOPs that end with B-frames are considered open. GOPs that end with P-frames are considered closed. For the present invention, preferable encoding is closed GOPs to ensure that there are no motion vectors pointing to frames that are outside of the current GOP. There is generally only one I-frame per GOP, but several P- and B-frames; however, it is actually not necessary to have any I-frames in a GOP at all.

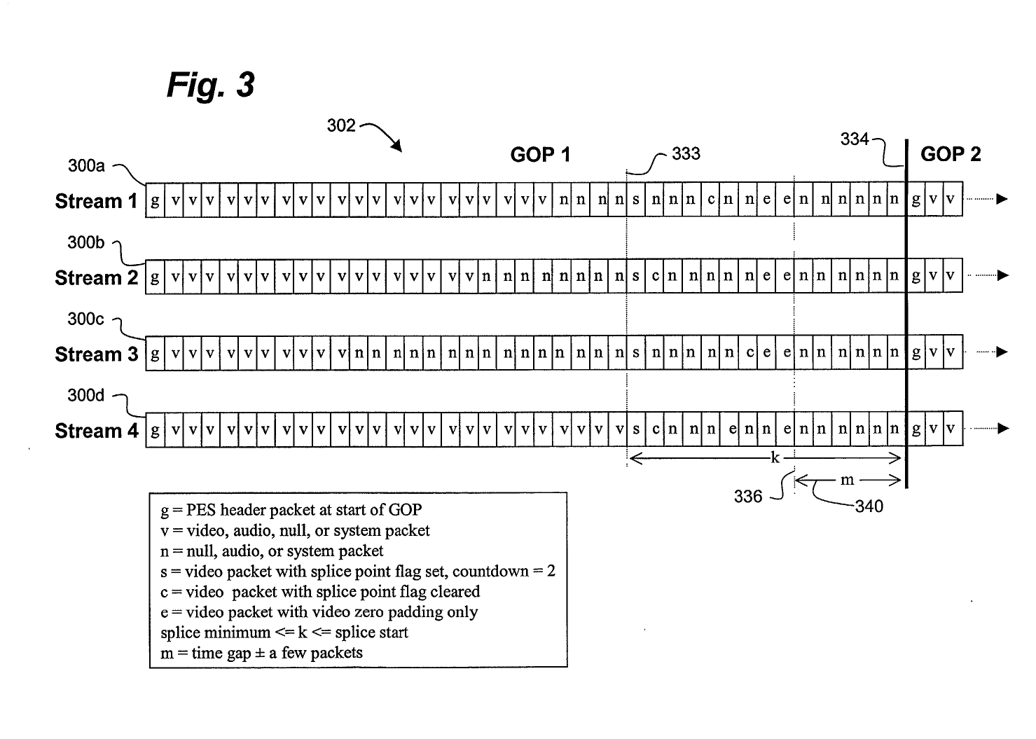

Certain modifications are made to the MPEG stream in order to facilitate the preferred seamless switching of video segments, preferably before transmission. These modifications to the encoding scheme are described below with reference to the video frame structure 302 shown in FIG. 3. Switches between the various program segments of a customized programming presentation occur prior to transmission at video splice points 336. The splice points 336 are identified via coding referred to as splice point flags and splice point counters, inserted into the MPEG adaptation fields of particular packets. Splice point flags indicate that splice point counters are present in other packets of the video segment accessed from the storage servers 314, set the value of a countdown timer, and initiate the countdown. When the splice point flag is cleared in a future packet, the countdown starts.

The splice point counters are actually packets, nominally identified as video packets in their adaptation fields, that decrement the countdown timer prior to the splice point 336. For example, suppose the countdown timer is set at two (2). The splice point 336 is the packet at which the countdown timer decrements to zero (0). Therefore, in this example, the switch will occur after the second video packet is found following the packet with the cleared splice flag.

With respect to creation of the video splice point 336, the encoder 312 may insert splice points 336 between every GOP in a stream. Preferably, the GOP is encoded as a “closed” GOP structure, i.e., concluding on a P-frame. Therefore, no motion vectors to the next GOP in the stream are present. If motion vectors cross from one GOP to the next GOP in the same stream, artifacts are created and visible in the presentation when the video signal is switched, because the B-frame will be pointing to frames in the GOP of the prior stream which do not exist in the new stream. Thus, a closed GOP structure is preferred for compliance with MPEG syntax and to ensure the absence of visible artifacts after execution of the splice.

MPEG also reorders the video frames from their original presentation order during the encoding process in order to code the video more efficiently. This reorder must be undone in the decoding process in order for the video to present properly.

| | GOP-1 | | | | | | | | | GOP-2 | | | | | | | | | | |
|---|---|---|---|---|---|---|---|---|---|---|---|---|---|---|---|---|---|---|---|---|
| Frame | 1 | 2 | 3 | 4 | 5 | 6 | 7 | 8 | 9 | 10 | 11 | 12 | 13 | 14 | 15 | 16 | 17 | 18 | 19 | 20 |
| Order: | | | | | | | | | | | | | | | | | | | | |
| Frame | I | B | B | P | B | B | P | B | B | P | I | B | B | P | B | B | P | B | B | P |
| Type: | | | | | | | | | | | | | | | | | | | | |
| Typical | 1 | 4 | 2 | 3 | 7 | 5 | 6 | 10 | 8 | 9 | 11 | 14 | 12 | 13 | 17 | 15 | 16 | 20 | 18 | 19 |
| Frame | | | | | | | | | | | | | | | | | | | | |
| Reorder | | | | | | | | | | | | | | | | | | | | |
| Transmission | I | P | B | B | P | B | B | P | B | B | I | P | B | B | P | B | B | P | B | B |
| Frame | | | | | | | | | | | | | | | | | | | | |
| Order: | | | | | | | | | | | | | | | | | | | | |

Splices occur at the end of the P-frame at the end of GOP-1 prior to the I-frame of GOP-2. It is important to point out that with appropriate controls the encoder 212 can code with variable GOP length and place splice frames accurately to achieve the desire interactive effect. If the content is unrelated, as is likely when creating Customized Programming, then the encoder 212 can splice at the end of every GOP allowing for a multiplicity of switching opportunities. Because the GOP ends on a P-frame, a closed GOP is yielded.

Each GOP is of variable length depending upon the complexity of the picture and the substantiality of changes between frames such as between scenes or changes of camera angles. Once a sequence of video frames is translated by MPEG into a GOP, the GOP is further divided into data packets for transmission. Each data packet is the same bit length and therefore, the individual frames in a GOP may be split across multiple data packets. In addition, some of the bits in a data packet may be audio information, system data or instructions, or even null filler data. The Customized Programming creation system chooses the desired frame at which to make the switch and during the encoding process codes selected packets in the GOP to implement the switch at the packet containing the end of the desired frame.

The GOP length is programmable and can be within one to infinite frames of video. It is preferred, however, that the GOP comprise ten to fifteen video frames. Referring to FIG. 3, four MPEG streams 300a-d are shown. For customized programming creation, it is desired that a seamless switch be available between any one video signal 300a and any other video signal 300b, c, or d. Seamless video switching occurs on a GOP video-frame boundary. For programming where “free” channel selection is required (e.g., live programming), all GOP boundaries are encoded as splice points 336. For pre-recorded material, splice points 336 need to be identified for switching between programming segments. In this case it may be desirable to indicate splice points 336 merely at the conclusion of a particular programming segment, for example, at the end of an advertisement. This will be the more likely scenario for customized programming creation applications.

FIG. 3 depicts four (4) parallel MPEG streams 300a-d of a typical channel bandwidth in an MPEG transmission system. Each stream shown consists of two successive GOPs. The first packet in each GOP is labeled “g” (this letter label “g” and each of the following labels “v,” “n, ” “k,” “s, ” “c, ” “e,” and “m” are merely identifiers for the sake of description herein only) and is a header packet which indicates the start of a new GOP. The g packet is followed by “v” packets which primarily contain the video information consisting of the I-, B-, and P-frames, but which also may contain audio or system related data. As noted, each GOP may be of variable length and therefore may consist of greater or fewer data packets than adjacent GOPs in the same data stream, e.g., 300a, or more significantly for switching purposes, than packets of a GOP in a parallel data stream, e.g., 300b, c, or d.

In order for a switch between data streams 300a-d to occur seamlessly, visible artifacts must be prevented. This is accomplished by ensuring that the switch occur before each stream reaches the beginning of its next GOP. Each GOP in a stream from or to which a switch is desired is preferably constructed with the same number of data packets. The packets should further be synchronized between the streams. As the number of packets with pertinent frame information in different GOPs will differ, additional packets are added as appropriate to achieve uniform GOP packet lengths between data streams 300a-d. These additional packets are labeled as “n” packets in FIG. 3. These packets may be merely sets of null data, or they may include additional audio or system command data.

Null n packets are added after the last packet containing video frame information. Enough n packets are added to bring each GOP packet group in the separate streams to the same number of packets. The splice start line 333 indicates the point at which the separate data streams 300a-d coincide in numbers of packets. The section of packets labeled “k” denotes the number of packets between the splice start 333 and the start of the next GOP 334. The number of packets shown is merely representative and should not be viewed as any limitation on the actual number of packets between the splice start 333 and the next GOP 334. The number of packets k is preferably, and at most, the number of packets between the splice start 333 and the start of the next GOP 334.

The number of packets k must be at least a minimum value, set as a variable in the controlling software, which is dependent upon the equipment used to implement the splice. The number of packets k will almost always be the number between the splice start 333 and the next GOP 334. However, the encoder will not insert the splice packet until all of the video packets have been produced for the current GOP. If the rate control fails to limit the number of video packets and the last video packet is produced less than the minimum number of packets from the position where the next GOP should start 334, the encoder will not produce splice packets for that stream, but will instead wait until the next GOP.

A nominal video packet with the splice point flag set, labeled “s” in FIG. 3, indicates the splice start 333. As shown, the s packets in each stream are synchronized with each other after the last video packet in Stream 4. By setting the splice point flag in the adaptation field, the multiplexer 324 and processor 358 are put on notice to prepare for a splice. In this example a countdown timer is set at a value of two (2) at the instance of the splice point flag. When a nominal video packet “c” with the splice point flag cleared arrives, the multiplexer 324 and processor 358 will implement the switch between streams at the appearance of the second video packet following the c packet clearing the splice point flag.

The nominal video packets which trip the countdown timer are labeled “e” in FIG. 3. These packets are described as “nominal” because, although they are identified as video packets in their adaptation field coding, they do not contain any substantive video information, but are merely filled with zero padding. At the appearance of the first e packet, the countdown timer decrements to one (1). When the second e packet arrives the countdown decrements to zero (0) and the processor 258 calls the operating routine from memory 254 that performs the switch.

The switch occurs in the multiplexer 224 by switching to a packet in a different data stream, for example from 300a to 300c. Instead of selecting the data packet identified by the next PID in the present data stream 300a, the multiplexer 224 chooses the synchronous PID from a corresponding data stream 300c. In order to choose the desired signal to which to switch, the multiplexer 224 identifies the PID of each incoming data packet and sends the PID information to the processor 258. Preferably, each incoming video and audio packet from the storage server 214 has its own PID. The processor 258 in turn identifies the next appropriate packets to select for transmitting to the user based on, for example, user preference information from the user information database 236 stored in memory 254, or user responses to interrogatories in the customized programming segments input through the user interface 148 at the receiver 108 (as shown in FIG. 1a), and received at the backchannel decoder demodulator 270 via a backchannel communication link. The switch could also be dictated at the direction of a producer at the transmission center 102. The interrogatory answers, user requests, producer directions, and user preference information, are processed by the processor 258 according to routines within the system software stored in memory 254 to select the indicated data packet and return the associated PID to the multiplexer 224. Alternatively, the desired PID may be part of the data codes, which are packetized as part of the program data stream. Upon receipt of the switching routine instructions, the multiplexer 224 begins to look for the designated MPEG packet by its PID. In alternative embodiments, depending upon the hardware used, the switch can be entirely controlled by the multiplexer 224, if for example it is constructed with a register to store PID information for switching.

After the second e packet, each GOP in the respective data streams 300a-d contains several more null n packets, identified by the number of packets “m”, prior to the first packet of the next GOP 334. These additional n packets create a time gap 340 to ensure that the switch is complete prior to the start of the start of the next GOP 334. As was previously discussed, MPEG may reorder the various video frames for transmission to maximize the compression capability. Similarly, when various data streams are multiplexed, the packets may be transmitted out of order to maximize the transmission capacity of the transmission bandwidth. The additional n packets creating the time gap 340 allow for mistakes in reordering the packets upon reception to assure that the last e packet will be queued before the start of the next GOP. The time gap 340 is primarily used for performing switching at the receiver 108. However, while the likelihood of packets becoming out of order when switching at the transmission center 102 is low, it is possible, and the time gap 340 is an equally applicable failsafe for use with the customized programming creation system.

This splicing method takes advantage of the non real time nature of MPEG data during transmission of the MPEG data streams 300a-d from a storage server 214 through the transmission system 250. For example, by encoding at a lower bit rate than the channel capacity, space is available for the additional null and switch packets to be inserted at the end of each GOP in order to make the switch. The multiplexer 224 will always find the PID in the header information of the first video packet of the GOP 334 of the new data stream, e.g., 300c, before the previously selected data stream, e.g. 300a, can be transmitted. In fact the data packets of the new data stream, e.g., 300c, are sent to the buffer 222 as the first data stream, e.g., 300a, continues to play out. Because an MPEG demultiplexer/decoder at a receiver 108 can decompress and decode even the most complex video GOP before the prior GOP is presented on the presentation device 110, the GOPs can be padded with the switching packets, including the time gap 340 packets, without any gap between the customized programming segments presented. In this way, separate data streams 300a-d are merged to create a single, seamless, syntactical MPEG transport stream 204 for transmission to the user.

While the switch will appear seamless, it need not occur immediately. For example, a user input or system command requires a finite time for processing. Therefore, a video switch may be delayed by up to 1.5 GOPs. Additionally, a splice point 336 can be placed accurately at any frame by utilizing the variable length of the GOP. Upon command from an external controlling device such as the data code generator 216, an encoder 212 can be directed to insert a splice at any frame number.

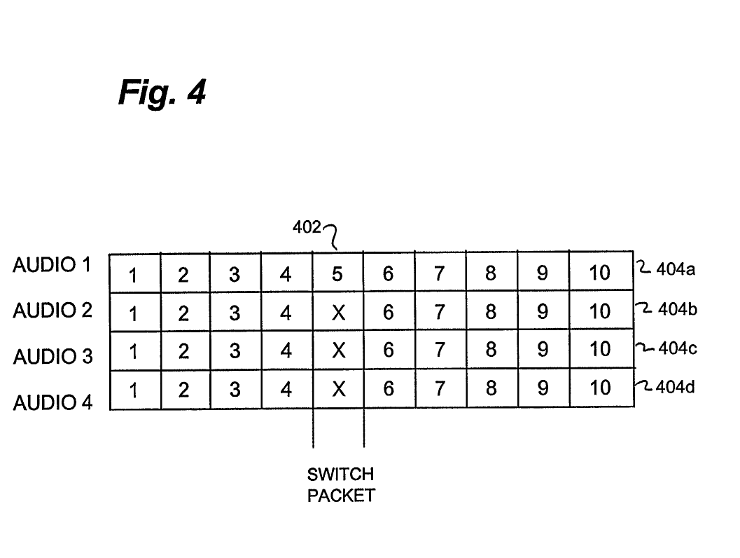

Similar to the video packet encoding, switching between audio segments preferably occurs on frame boundaries, as shown in the digital frame representation 402 of four audio streams 404a-d in FIG. 4. Audio splice points are inserted in the adaptation fields of data packets by the encoder 212 similar to the video splice points 336 of FIG. 3. Preferably, the encoder 212 inserts an appropriate value in a splice countdown slot in the adaptation field of the particular audio frame. When the multiplexer 224 detects the splice point inserted by encoder 212, it switches between audio channels supplied in the different program streams 404a-d. The audio splice point is preferably designated to be a packet following the video splice point 336 packet, but before the first packet of the next GOP 334 of the prior program stream. When switching from one stream to another, for example from 404a to 404b, c, or d, one frame may be dropped (in this case, frame 5) resulting in a brief muting of the audio. The audio then resumes with frame 6 of the new stream. Although the audio splice is not seamless, the switch will be nearly imperceptible to the user. Other methodologies, such as those provided in MPEG-4 and -7 offer further audio mixing and switching options that may allow for seamless audio switching when following those encoding guidelines.

The data codes generated by data code generator 216 are time sensitive in the digital embodiments and must be synchronized with the video GOPs, as well as the audio packets, at the time of creation and encoding of the customized programming segments. Data codes are preferably formed by stringing together two six-byte long control commands, however, they can consist of as few as two bytes, much less than the standard size of an MPEG data packet. MPEG protocol normally waits to accumulate enough data to fill a packet before constructing a packet and outputting it for transmission or, in this case, storage. In order to ensure timely delivery of the data codes from storage servers 214 to the multiplexer 224 for synchronization with content filled packets, the encoder 212 must output individual commands as whole packets, even if they are not so large in size. If a data code command creates only a partial packet, the default process of the encoder 212 is to delay output of the data code packet until subsequent data codes fill the remainder of the packet. One technique that can ensure timely delivery of the data codes is to cause the data code generator 216 to create placeholder bytes to pad the remaining bytes for a packet. When the encoder 212 receives this data code with enough data for a whole packet, the encoder 212 will output the packet for storage in storage servers 214 at its earliest convenience, assuring synchronous receipt of the data codes at the multiplexer 224 with the corresponding programming packets at the time of transmission.

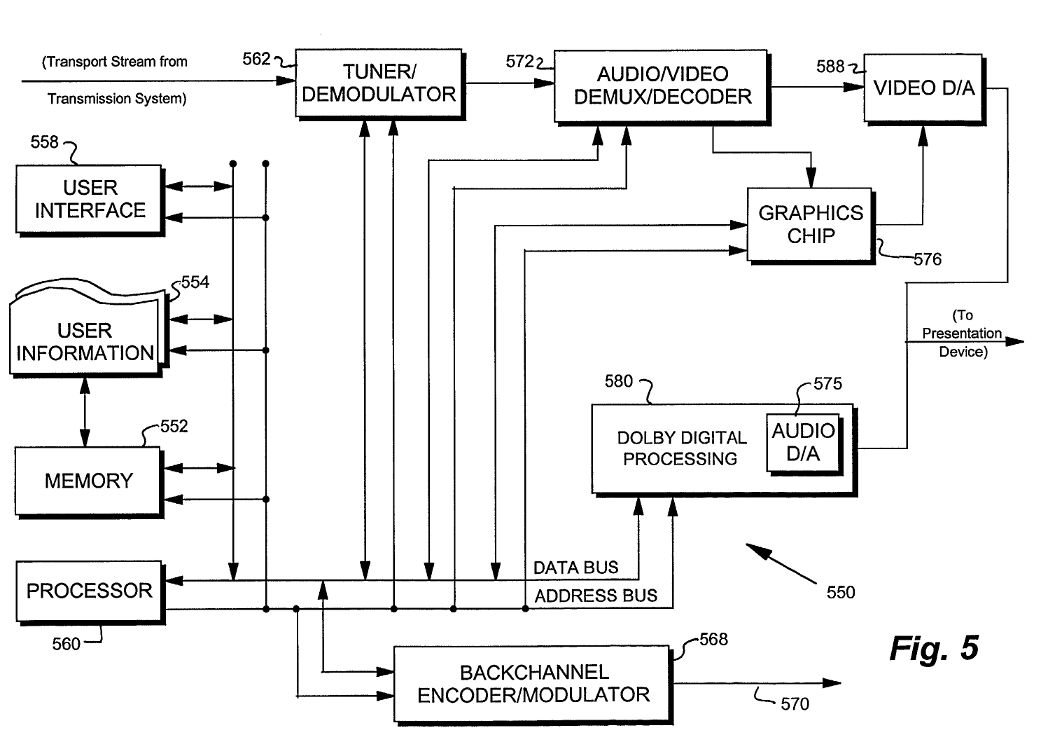

A receiver 550, preferably consisting of the elements shown in FIG. 5, is preferably located at each reception site. The data transport stream 104 is received via a tuner mechanism 544. The tuner 544 may be a wide band tuner, in the case of satellite distribution, a narrow band tuner for standard NTSC signals, or two or more tuners for switching between different signals located in different NTSC frequency channels. The tuner 544 tunes to the particular NTSC channel at the direction of the processor 560. The processor 560 is preferably a Motorola® 68331 processor, but may be any conventional processor including PowerPC® and Intel Pentium® processors. The tuned channel is then demodulated by the demodulator 564 to strip the transport stream 104 (as depicted in FIG. 1a) from the carrier frequency at the desired channel in the received transmission.

The demodulated transport stream 104 is then forwarded to the demultiplexer/decoder (“demux/decoder”) 572. At the demux/decoder 572, the packets in the transport stream 104 are separated and decompressed. Preferably, each incoming data packet in the transport stream 104 has its own PID. The demux/decoder 572 strips off the PID for each packet, and sends the PID information to the processor 560. The processor 560, at the direction of system software stored in the memory 552, identifies the next appropriate packet to select for presentation to the user by comparing the PID to selection information or other criteria. The demux/decoder 572 then reconstitutes the selected digital programming signals from their packetized and compressed form and routes them to an appropriate digital to analog (“D/A”) decoder, whether video, audio, or otherwise.

The memory 552 is preferably ROM, which holds operating system software for the receiver 550, and is preferably backed up with flash-ROM to allow for the reception and storage of downloadable code and updates. In the preferred embodiment, the system software can access and control the hardware elements of the device. Further, new software applications may be downloaded to the receiver 550 via either the transport stream 104 or a backchannel communication link 570 from the transmission system 250. These applications can control the receiver 550 and redefine its functionality within the constraints of the hardware. Such control can be quite extensive, including control of a front-panel display, on-screen displays, input and output ports, the demux/decoder 572, the tuner/demodulator 562, the graphics chip 576, and the mapping of the user interface 558 functions.

Additional memory 552 in the form of RAM or a storage server may be used at the receiver 550 in order to store programming segments, either temporarily for incorporating into a customized program, or for a longer period if the program segment is likely to be repeatedly desired or used in customized programming for the particular user. A programming segment could also be transmitted earlier than the desired presentation time and stored in memory 558 to be used to further customize a later transmitted program segment that is transmitted to a group of users.

An interactive programming system 100 is preferably used to provide additional functionality for provision of the customized programming segments. Such a system is preferably implemented as a software application within the receiver 550 and is preferably located within ROM or flash-ROM memory 552. The interactive system software, however, could alternatively be located in any type of memory device including, for example, RAM, EPROM, EEPROM, and PROM. The interactive programming system 100 preferably solicits information from the user by presenting interactive customized programming segments, which may provide questionnaires, interrogatories, programming selection options, and other user response sessions. The user responds to such queries through the user interface 558. A user may interact with the user interface 558 via an infrared or radio frequency remote control, a keyboard, touch screen technology, or even voice activation. The user information 554 collected can be used immediately to affect the programming segments presented to the user, stored in memory 552 for later use with other programming selection needs, including the targeting programming component selection of the present invention, or incorporated into the user information file 554.

The receiver 550 also preferably includes a backchannel encoder/modulator 568 (hereinafter, “backchannel 568”) for transmission of data to the transmission system 250 or to the user information database 236 over the backchannel communication link 570. Data transmitted over the backchannel communication link 570 may include user preference information collected at the receiver 550 or even direct user input, including interactive selections, made via the user interface 558. As previously noted, the backchannel 568 can also receive data from the transmission system 250 via backchannel communication link 570, including software updates and user preference information from the user information database 236. The backchannel communication link 570 may by any appropriate communication system such as two-way cable television, personal satellite uplink, the Internet, telephony, T-1 upstream, digital subscriber line, wireless telephony, or FM transmission.

Reconstructed video segments are output from the demux/decoder 572 to video D/A converter 588 for conversion from digital-to-analog signals for final output to a presentation device 110 (as shown in FIG. 1). Such D/A conversion may not be necessary if the presentation device 110 is also a digital device. An attached presentation device 110 may comprise a television, including high definition television, where the monitor may comprise a tube, plasma, liquid crystal, and other comparable display systems. In other embodiments of the invention, the presentation device 318 may be, for example, a personal computer system, a personal digital assistant, a cellular or wireless PCS handset, a telephone, a telephone answering device, a telephony device for the deaf, a web pad, a video game console, and a radio.

Graphics components are preferably output from the demux/decoder 572 to a graphics chip 576 to transform the graphics to a video format. The graphics components are then prepared for output to the presentation device 110 in the video D/A converter 588. Video and graphics components (as well as audio and other components) may also be temporarily stored in memory 552, or in a buffer (not shown), for rate control of the presentation or other delay need (for example to store graphic overlays for repeated presentation), prior to analog conversion by video D/A converter 588.

The associated digital audio programming components are decoded by demux/decoder 572 and preferably sent to a digital audio processor 580. The digital audio programming components are finally transformed back into analog audio signals by audio D/A converter 575 for output to the presentation device 110. The digital audio processor 580 is preferably a Dolby® digital processing integrated chip for the provision of, for example, surround sound, which includes an audio D/A converter 575. Data codes are also separated from the transport stream 104 by the demux/decoder 572 and are conducted to the processor 560 for processing of data commands.

It may be appreciated that such a customized programming system requires a significant infrastructure of switching equipment at the transmission center 102, both for switching between program streams and switching between the customized programming feeds from the storage servers 214. Further, in a transmission system 250 comprising a distribution network, each user participating in a customized programming session will be assigned a single transmission interface such as a socket connection to allow the one to one customized programming. These transmission interfaces are dynamically allocated to users who request access to customized programming. At the transmission center 102, a single interface is assigned to a single user so the number of interfaces present at the transmission center 102 can be the limiting factor to the number of users who can participate in a customized programming session simultaneously. If it is assumed that only a portion of the users will interact simultaneously, an algorithm is used to determine the optimum number of central switches necessary to assure an acceptable percentage of access.

Other configurations of distribution networks are possible to reduce the one to one need. Parallel processing capabilities can accommodate multiple, simultaneous accessing of programming from the storage servers 214 and switching between transport streams. Further, nodal distribution systems using multiple servers can accommodate significant numbers of users. The system software replaces the hardware to perform the switching operations and increased demand from users for customized programming is accommodated simply by the provision of larger or additional servers. Digital transmission systems provide increased bandwidth and such a large channel capacity that customized programming could be provided to multiple users through the unused channel capacity. In fact, with some transmission systems such as fiber optic, bandwidth is for many purposes not an issue and user demand can be easily met through the capacity of the transmission system itself.

In order to provide customized programming it is preferable to utilize the storage and transmission system disclosed herein in conjunction with a system that provides information about the users in order to more accurately provided appropriate and desired customized programming. Such information could be a simple as geographic location, which may also provide some demographic overtones. It is preferable, however, to have as much information as possible about users in order to customize programming as accurately as possible. Addressable transmission systems such as digital cable and digital broadcast satellite television provide the ability to identify, interact with, and provide particular programming (e.g., pay-per-view-programming) directly to individual users, as well as collect more extensive information about them. Such information can include television viewing preferences, e.g., by capturing event programming guide information, and more particularized geographic and demographic data. If the transmission system 250 is interactive, queries can be presented to users to solicit additional user information, which can be compiled and analyzed to provide more focused programming content. Further, if the user participates in any television/Internet convergence programming offerings, additional information about the user's Internet usage can be used to establish a profile of the user, or profiles of groups of users, to allow the presentation of more customized programming.

The splice points 336 that trip the seamless switching between program segments may be placed in program segments based on user inputs through user interface 558, producer control at the transmission center 102, commands embedded the programming segments (e.g., interactive programming codes), and the user preference information gathered and stored in the interactive programming system 100. In a preferred embodiment of the customized programming creation system, the user information database 136 shown in FIG. 1a as storing the user preference information is part of a user profile system, which is implemented in conjunction with the interactive programming system 100. Such a user profile system is disclosed in U.S. patent application Ser. No. 09/409,035 entitled Enhanced Video Programming System and Method Utilizing User-Profile Information, which is hereby incorporated herein by reference. The user profile system provides a specific methodology for implementing the collection, processing, management, and use of user preference information, referred to as a user profile, to make programming segment selections in the customized programming system.

In general, the transmission system 250, the reception system 550, and the user profile system are all interconnected via a network communication system, preferably the Internet. The preferred user profile system creates a “donut” of dynamic, hierarchical, shared user profile information. A donut may specify the following: user characteristics, viewing preferences, hobbies, geographic location, and spending habits among others. The donut contains a user profile or acts as a key to a data repository containing it, and it may be stored in a file-type structure on a computer-readable medium such as a memory. The donut is accessed by browser programs, associated web server programs, and other applications for use in routing content to the user machine associated with the donut. The user machine may include a wide variety of devices such as, for example, a personal computer, a television, a cable receiver, a satellite receiver, a video game console, and a personal digital assistant.

Browser programs typically support a file created by a web server to locally store data on a user's device and track information storage locations, such as web sites, identified by Uniform Resource Locations (URLs), accessed by the user through the browser program. These files are referred to as “cookie” files, which contain a range of URLs for which they are valid. In this sense they are filters that only become active when they recognize identifiers of particular information storage locations when a connection is made. Typical data collected in a cookie file can include: a user identifier, a history of user visits to the particular site, purchasing information, creation of a virtual shopping basket during a visit, etc. When the browser encounters the URLs again, it sends the corresponding cookie files to the web server identified by the URLs.

In the present invention, the system software of the transmission system 250 and user receiver 550 preferably include browser software. Thesebrowsers may access a donut file or database structure storing donuts, and web servers may include files or other database structures for storing copies of the donut. The donut file for a particular user is typically stored only on a data storage server at the transmission center 102, or other remote location, but could be stored locally in memory on the user's receiver 550 or on both the server and the user's receiver 550. The donut thus implements a dynamic store of shared profile data that is exchanged between the user's receiver 550 (client) and server, with the flexibility to collect and process that data in three ways: client-side evaluation, http-based server-side evaluation, and network-based server-side evaluation.

The donut has an advantage over a cookie file in that the donut file is database driven and typically stored on a server, preventing a user from deleting or otherwise tampering with the donut file. Cookie files, in comparison, are stored locally on a user's machine. In addition, by storing a donut file on a server, a user may log onto a network from any machine and still access the user's donut file and receive content based upon the donut file.

A donut, more specifically, is a hierarchical attribute value pair data structure, including a collection of “crumbs”. A crumb is the smallest unit of data corresponding to a meaning value pair associated with a particular donut. For example, a user's age would be a crumb associated with the user's primary donut. The donut data structure includes names plus associated crumbs. At the top level of the hierarchy, a top donut is associated with a user, a chat room, a network service, or other appropriate business entity or service. Each donut contains a set of crumbs and a set of “sub-donuts.”

A sub-donut is a donut associated with another donut rather than an external entity such as, for example, a user. An example of a sub-donut is a user's address. The user's address references the user's primary donut and is stored in a sub-donut, and the sub-donut contains crumbs for each piece of information in the address. Donuts are stored with hierarchical relationships, meaning that a donut can have associated sub-donuts and the sub-donuts can also each have associated sub-donuts. The donut thus may have many levels of sub-donuts within its hierarchical structure.

Some donuts are owned by only one parent donut. Other donuts are shared among several or many parent donuts. These shared donuts profile a business entity, such as an individual program, that is common to all; an example includes members of the same chat room. This provides a way to identify a group of users for a chat service. In the present context, customized programming may be selected for presentation to a group of users who share similar profile characteristics. Also, by sharing the donut, a user need not enter a new profile for using different services; the services share and use the one donut.

The user profile may contain a wide variety of information concerning user characteristics for use in determining content to push to a user. The content may include any type of information such as video, audio, graphics, text, and multimedia content. Examples of content to be selectively pushed to the user as part of the customized programming creation system based upon the user profile information include, but are not limited to, the following: advertisements, player profiles for sporting events, music or other audio information, icons representing particular services, surveys, news stories, and program suggestions. For example, through an interactive survey, the customized programming creation system can dynamically modify and update a user's donut to further fine-tune the process of selecting particular content to push to the user based upon the user's donut. In advertising context, the answers to survey questions may be used to provide a second level of information within an advertisement pushed to a particular user. The customized programming creation system may use demographic data in a user's donut, for example, to determine which advertisement or survey to push to the user. The user's answers to questions in the survey may be used to push additional advertisements to the user or additional content related to the advertisement previously pushed.

An execution environment for donuts may be implemented with an easily programmed JAVA module which can obtain crumb values from a donut service, branch on those values and other conditions, set existing crumb values, and create new crumbs as desired. A module processing a donut can execute in three modes: as a Hypertext Transfer Protocol (HTTP) servlet connected directly to a database for donut persistence; as a service responding to requests coming through a distributed community network and unconnected to a database for donut persistence; and on the client machine, which has direct access to user input, but uses the donut persistence by proxy through a distributed community network. An example of a distributed community network is disclosed in U.S. patent application Ser. No. 09/396,693 filed Sep. 15, 1999.

The transmission system 250 processor 258 and the receiver 550 processor 560 mayo monitor the user's activity in order to dynamically update the user's donut. The user's activity may involve any type of information relating to the user's interaction with the network or program content provided to the user. For example, the user profile system may detect the following: programming viewed by the user; user viewing habits; advertisements viewed or not viewed; the rate at which the user selects or “clicks on” URLs to request particular content; which URLs the user selects; the amount of elapsed time the user has remained logged onto the network; the extent to which the user participates in chat room discussions; responses to interactive segments; other input from the user; and any other such information.

The user profile system also determines whether to update the user's donut based upon the monitored user activity. This determination may be based upon particular criteria related to the user's activity. For example, the user profile system may store particular types of activity or thresholds for activity for comparison to the user's monitored activity, providing for an update when the user's activity matches the particular types of activity or exceeds the thresholds. It may also be updated based upon survey questions. If the transmission system 250 processor 258 determines based on the criteria that the user's donut is to be updated, it dynamically updates the donut based on the user's activity, saves the updates, and optionally sends the updates to the user's receiver 550. Otherwise, if the criteria have not been met, the processor 258 does not update the donut.

This donut methodology can be translated from an individual user based profile to a macro scale providing local, regional, and system-wide profiles. These macro system profiles can be used in the selection of programming for storage in storage servers 214 at the particular system site. For example, particular programming may be especially popular in the Southeast of the United States of America, while not commanding any sizeable audience in Utah. In this case it would not make sense for transmission centers 102 in Utah to store that particular programming in their storage servers 214. Creating regional and system-wide donut profiles can sensibly allocate programming storage to locations of highest demand. Programming that is universally popular may be redundantly stored at multiple transmission centers 102 to accommodate demand. The length of time that particular programming is saved in storage at a particular transmission system location may be part of the donut variables as well. Factors such as strength of demand, the average window in which users request such programming, the timeliness or currency of the programming (e.g., a weather forecast), etc., can be used in a donut scheme to for stocking and turning over the programming libraries in the transmission system.

Through the combination of the data storage and accessing capabilities of data file servers, interactive programming technology, seamless program switching, and the methodology of profiling user preference information, the inventive concept of customized programming creation is achieved. In this manner, users benefit from receiving programming and advertisements of interest to them at the time they want to receive it. In turn, advertisers are able to more particularly target consumers with a potential affinity for the particular product or services offered.

What is claimed is:

1. A method of providing customized programming in a digital interactive programming system from a programming transmission center to at least one user, the customized programming comprising a succession of digital program segments selected by the interactive programming system from a plurality of digital program segments according to user preference information of the at least one user, the customized programming selected to appeal to the programming preferences of the at least one user, the method comprising:
accessing user preference information indicating the programming preferences of the at least one user;
selecting and accessing a first digital program segment of the succession of digital program segments from the plurality of digital programming segments according to the user preference information of the at least one user;
transmitting the first digital program segment to a reception system of the at least one user;
identifying a splice point in the first digital program segment before the completing the step of transmitting;
selecting and accessing a second digital program segment of the succession of digital program segments from the plurality of digital program segments according to the user preference information;
seamlessly switching from the first digital program segment to the second digital program segment at the splice point identified in the first digital program segment, wherein the switch occurs without creating any artifacts perceptible when the succession of digital program segments is presented to the at least one user; and
transmitting the second program segment to the reception system of the at least one user.

2. A method of providing customized programming as described in claim 1 further comprising the step of storing the plurality of digital program segments on at least one storage server at the programming transmission center, and wherein the succession of digital program segments is accessed from the at least one storage server.

3. A method of providing customized programming as described in claim 2 wherein the at least one storage server is selected from the group consisting of: a data storage server, magnetic storage media, optical storage media, video tape, audio tape, compact disk, video disk, and mini-disk.

4. A method of providing customized programming as described in claim 1 further comprising the step of encoding the succession of digital program segments with the splice point.

5. A method of providing customized programming as described in claim 2 further comprising the step of encoding the succession of digital program segments with the splice point before the step of storing.

6. A method of providing customized programming as described in claim 4 wherein the succession of digital program segments are encoded according to MPEG standards.

7. A method of providing customized programming as described in claim 1 wherein the digital interactive programming system further comprises a user profile system and wherein the user preference information ins accessed from the user profile system.

8. A method of providing customized programming as described in claim 2 further comprising the step of compressing the succession of digital program segments before the step of storing.

9. A method of providing customized programming as described in claim 8 wherein the succession of digital program segments are compressed according to MPEG standards.

10. A method of providing customized programming as described in claim 1 further comprising the step of receiving user preference information from the at least one user via a backchannel communication link between the reception system of the at least one user and the programming transmission center.

11. A method of providing customized programming as described in claim 10 wherein the backchannel communication link is a communication system selected from the group consisting of: radio, telephony, wireless telephony, a communication network, the Internet, two-way cable, digital subscriber line, fiber optic, and satellite.

12. A method of providing customized programming as described in claim 1 wherein the step of accessing further comprises the steps of requesting and receiving at least one digital program segment from a remote transmission source.

13. A method of providing customized programming as described in claim 12 wherein the remote transmission source is selected from the group consisting of: a local transmission center, a regional transmission center, a local broadcast center, and a national broadcast center.

14. A method of providing customized programming as described in claim 14 wherein the transmission received from the remote transmission source is received via a transmission medium selected from the group consisting of: terrestrial television broadcast, cable, satellite, fiber optic, point-to-point microwave, radio, telephony, wireless telephony, the Internet, a private network, and a communication network.

15. A method of providing customized programming as described in claim 12 further comprising the step of selecting at least one digital program segment from the remote transmission source according to information within a library database of a library of digital program segments stored at the remote transmission source.

16. A method of providing customized programming as described in claim 15 further comprising the step of updating the programming library according to a set of rules governing the database profile wherein the set of rule dictate which of the digital program segments are to be stored, a location for storing the digital program segments, and a period of time for storage, and wherein the rules are based upon an aggregation of related user preference information of a plurality of users.

17. A method of providing customized programming as described in claim 1 wherein the step of accessing further comprises retrieving digital program segments from the Internet via a communication link between the programming transmission center and the Internet.

18. A method of providing customized programming as described in claim 1 wherein the step of accessing further comprises retrieving digital program segments from a private network via a communication link between the programming transmission center and the private network.

19. A method of providing customized programming as described in claim 1 wherein the steps of transmitting are performed over a transmission medium selected from the group consisting of: terrestrial television broadcast, cable, satellite, fiber optic, microwave, radio, telephony, wireless telephony, the Internet, a private network, and a communication network.

20. A method of providing customized programming as described in claim 1 wherein the plurality of digital program segments comprise programming selected from the group consisting of: audio, video, still-frame video, multimedia, graphic image, animation, data, programming applications, and text.

21. A method of providing customized programming as described in claim 1 wherein the steps of transmitting are performed over a narrow bandwidth transmission medium.

22. A method of providing customized programming as described in claim 1 wherein the customized programming is transmitted to a plurality of users whose user preference information indicates common programming preferences.

23. A method of providing customized programming as described in claim 10 further comprising the step of receiving the user's input or a response to the at least one user to at least one interrogatory contained in the succession of digital program segments at the programming transmission center via the backchannel communication link, wherein the selection of the succession of digital program segments is further determined by the interactive programming system based upon responses of the at least one user to the posited interrogatories.

24. A method of providing customized programming as described in claim 4 wherein the step of encoding further includes encoding at least one data command in at least one of the digital program segments, the data commands encoded for instructing reception system of the at least one user to retrieve additional digital program segments over a communication network wherein the communication network is selected from the group consisting of the Internet and a private network.

25. A programming transmission system in a digital interactive programming system for providing customized programming from a programming transmission center to at least one user utilizing an interactive programming system, the customized programming comprising a succession of digital program segments selected by the interactive programming system from a plurality of digital program segments according to user preference information of the at least one user, the customized programming selected to appeal to the programming preferences of the at least one user, the programming transmission system comprising:
a program selector which selects and accesses the succession ofdigital program segments from the plurality of digital program segments, wherein the succession of digital program segments selected are determined in individual succession by the interactive programming system based upon user preference information of the at least one user;
a memory which stores the user preference information;
a data filter which identifies a splice point in each of the succession of digital program segments;
a program switcher which switches between a prior digital program segment and a successive digital program segment in the succession of digital program segments at the splice point of the prior digital program segment, wherein a seamless switch occurs without creating any artifacts perceptible when the succession of digital program segments is presented to the user;
a processor that coordinates the functions of the program selector, the data filter, the program switcher, and the interactive programming system; and
a programming transmitter that transmits the successive digital program segments to the at least one user.

26. A programming transmission system for providing customized programming as described in claim 25 further comprising at least one storage server for storing the digital program segments.

27. A programming transmission system for providing customized programming as described in claim 26 wherein the at least one storage server is selected from the group consisting of: a data storage server, magnetic storage media, optical storage media, video tape, audio tape, compact disk, video disk, and mini-disk.

28. A programming transmission system for providing customized programming as described in claim 25 further comprising backchannel receiver that receives user preference information from a receiver of the at least on user over a backchannel communication link between the programming transmission center and the receiver of the at least one user

29. A programming transmission system for providing customized programming as described in claim 28 wherein the backchannel communication link is a communication system selected from the group consisting of: radio, telephony, wireless telephony, a communication network, the Internet, a digital subscriber line, cable, fiber optic, and satellite.

30. A programming transmission system for providing customized programming as described in claim 25 wherein the memory comprises a computer readable medium selected from the group consisting of: a data storage server, optical storage media, and magnetic storage media.

31. A programming transmission system for providing customized programming as described in claim 25 further comprising a receiver that receives the digital program segments via a transmission from a remote transmission source.

32. A programming transmission system for providing customized programming as described in claim 31 further comprising a database profile of a programming library of digital program segments, wherein the library of digital program segments is stored at least one of the remote transmission sources.

33. A programming transmission system for providing customized programming as described in claim 32 wherein the programming library is updated according to a set of rules governing the database profile which dictates the digital program segments to be stored, a location for storing the digital program segments, and a period of time for storage, and wherein the rules are based upon an aggregation of related user preference information of multiple users.

34. A programming transmission system for providing customized programming as described in claim 31 wherein the remote transmission source is selected from the group consisting of: a local transmission center, a regional transmission center, a local broadcast center, and a national broadcast center.

35. A programming transmission system for providing customized programming as described in claim 31 further comprising at least one storage server that stores the digital program segments received from the remote transmission source.

36. A programming transmission system for providing customized programming as described in claim 31 wherein the program selector accesses the digital program segments directly from the receiver.

37. A programming transmission system for providing customized programming as described in claim 31 wherein the transmission received from the remote transmission source is received via a transmission medium selected from the group consisting of: terrestrial television broadcast, cable, satellite, fiber optic, microwave, radio, telephony, wireless telephony, the Internet, a private network, and a communication network.

38. A programming transmission system for providing customized programming as described in claim 25 wherein the programming transmitter transmits the digital program segments over a transmission medium selected from the group consisting of: terrestrial television broadcast, cable, satellite, fiber optic, microwave, radio, telephony, wireless telephony, the Internet, a private network, and a communication network.

39. A programming transmission system for providing customized programming as described in claim 25 wherein the digital program segments comprise programming selected from the group consisting of: audio, video, still-frame video, multimedia, graphic image, animation, data, programming applications, and text.

40. A programming transmission system for providing customized programming as described in claim 25 wherein the programming transmitter transmits the digital program segments via a narrow bandwidth transmission medium.

41. A programming transmission system for providing customized programming as described in claim 25 wherein the customized programming is transmitted to a plurality of users whose user preference information indicates common programming interests.

42. A programming transmission system for providing customized programming as described in claim 28 wherein one or more of the digital program segments contain interrogatories for interacting with the particular user, and wherein the backchannel receiver receives user responses to the interrogatories or other user input via the backchannel communication link between the programming transmission center and the particular user's receiver, whereby the digital program segments selected are determined by the interactive programming system based upon user responses to the posited interrogatories and other user input.

43. A programming transmission system for providing customized programming as described in claim 25 wherein the digital program segments are compressed and encoded according to MPEG standards.

44. A programming transmission system for providing customized programming as described in claim 43 wherein the splice points are MPEG codes.

45. A programming transmission system for providing customized programming as described in claim 25 wherein a data command in the digital program segments instructs a particular user's receiver to retrieve additional digital program segments from the Internet.

46. A programming transmission system for providing customized programming as described in claim 25 wherein a data command in the digital program segments instructs a particular user's receiver to retrieve additional digital program segments from a private network.

47. A programming transmission system for providing customized programming as described in claim 25 wherein the data filter comprises a digital multiplexer.

48. A programming transmission system for providing customized programming as described in claim 25 wherein the program switcher comprises a digital multiplexer.

49. A programming transmission system for providing customized programming as described in claim 25 further comprising a data rate controller which controls the rate at which the successive digital program segments are transferred to the programming transmitter, thereby varying the rate of transmission of the digital program segments to coordinate the transmission rate with the filling and outflow rates of a buffering component in a receiver at a user's location.

50. A method of creating customized programming for transmission within an interactive programming system comprising the steps of:
selecting multiple digital program segments;
encoding a splice point within one or more of the digital program segments to facilitate a seamless switch to another of the digital program segments;
compressing the digital program segments; and
storing the selected digital program segments on one or more storage servers accessible by a programming transmission center.

51. A method of creating customized programming as described in claim 50 wherein the step of selecting is performed by the interactive programming system based upon user preference information of a particular user.

52. A method of creating customized programming as described in claim 50 wherein the step of selecting is performed by the interactive programming system based upon user preference information of a plurality of users with common programming interests.

53. A method of creating customized programming as described in claim 50 wherein the step of selecting is performed by the interactive programming system based upon a set of rules governing a database profile which dictates the digital program segments to be stored, a location for storing the selected digital program segments, and a period of time for storage, and wherein the rules are based upon an aggregation of related user preference information of multiple users.

54. A method of creating customized programming as described in claim 50 wherein the steps of encoding and compressing are performed according to MPEG standards.

55. A method of creating customized programming as described in claim 50 wherein the storage servers are selected from the group consisting of: data storage servers, magnetic storage media, optical storage media, video tapes, audio tapes, compact disks, video disks, and mini-disks.

56. A method of creating customized programming as described in claim 50 wherein the storage servers are located at the programming transmission center.

57. A method of creating customized programming as described in claim 50 wherein one or more of the storage servers are located at a remote transmission source from which the programming transmission center requests and receives digital program segments.

58. A method of creating customized programming as described in claim 57 wherein the remote transmission source is selected from the group consisting of: a local transmission center, a regional transmission center, a local broadcast center, a national broadcast center, an Internet server, and a private network server.

59. A method of creating customized programming as described in claim 50 wherein the digital program segments comprise programming selected from the group consisting of: audio, video, still-frame video, multimedia, animation, graphic image, and text.

60. A method of creating customized programming as described in claim 50 wherein the digital program segments comprise still-frame video for transmission via a low bandwidth transmission medium.

61. A method of creating customized programming as described in claim 50 wherein the step of encoding further includes encoding one or more data commands in one or more of the digital program segments, the data commands for instructing receiving equipment at a user's location to retrieve additional digital program segments from the Internet.

62. A computer program product for instructing a computer controlled programming transmission system with interactive programming technology to provide customized programming to a user, the computer program product comprising a computer readable medium having computer readable program code embodied therein for controlling the programming transmission system, the computer readable program code comprising instructions for:
causing the programming transmission system to access information in a user preference;
causing the programming transmission system to select and access a first digital program segment, wherein the particular digital program segment selected as the first digital program segment is determined by the interactive programming system based upon the user preference information of a particular user;
causing the programming transmission system to transmit the first digital program segment to the particular user;
causing the programming transmission system to identify a splice point in the first digital program segment prior to the completion of its transmission to the user;
causing the programming transmission system to select and access a second digital program segment, wherein the particular digital program segment selected as the second digital program segment is determined by the interactive programming system based upon user preference information of the particular user;
causing the programming transmission system to seamlessly switch from the first digital program segment to the second digital program segment at the splice point identified in the first digital program segment, whereby the switch is accomplished without a user perceptible delay between the digital program segments; and
causing the programming transmission system to transmit the second digital program segment to the particular user, thereby providing an uninterrupted customized program transmission to the particular user.

63. A computer program product as described in claim 62 wherein the computer readable program code further comprises instructions for causing the programming transmission system to store the digital program segments on one or more storage servers at the programming transmission center, whereby the digital program segments are accessed from the storage servers.

64. A computer program product as described in claim 62 wherein the computer readable program code further comprises instructions for causing the programming transmission system to encode one or more of the digital program segments with the splice point.

65. A computer program product as described in claim 62 wherein the computer readable program code further comprises instructions for causing the programming transmission system to encode one or more of the digital program segments with the splice point before causing the programming transmission system to store the digital program segments.

66. A computer program product as described in claim 64 wherein the digital program segments are encoded according to MPEG standards.

67. A computer program product as described in claim 65 wherein the digital program segments are encoded according to MPEG standards.

68. A computer program product as described in claim 62 wherein the computer readable program code further comprises instructions for causing the programming transmission system to compress the digital program segments prior to the step of storing.

69. A computer program product as described in claim 68 wherein the digital program segments are compressed according to MPEG standards.

70. A computer program product as described in claim 62 wherein the computer readable program code further comprises instructions for causing the programming transmission system to receive user preference information from the particular user via a backchannel communication link between a particular user's receiver and the programming transmission center.

71. A computer program product as described in claim 70 wherein the backchannel communication link is a communication system selected from the group consisting of: radio, telephone, wireless telephone, a communication network, cable, fiber optic, and satellite.

72. A computer program product as described in claim 71 wherein the communication network comprises the Internet.

73. A computer program product as described in claim 70 wherein the computer readable program code further comprises instructions for causing the programming transmission system to store the user preference information in a memory module at the programming transmission center.

74. A computer program product as described in claim 73 wherein the memory module is a computer readable medium selected from the group consisting of: a data storage server, optical storage media, and magnetic storage media.

75. A computer program product as described in claim 62 wherein the instructions for accessing further comprise instructions for causing the programming transmission system to request and receive the digital program segments from a remote transmission source.

76. A computer program product as described in claim 75 wherein the remote transmission source is selected from the group consisting of: a local transmission center, a regional transmission center, a local broadcast center, and a national broadcast center.

77. A computer program product as described in claim 75 wherein the transmission received from the remote transmission source is received via a transmission medium selected from the group consisting of: terrestrial television broadcast, cable, satellite, fiber optic, microwave, radio, telephone, wireless telephone, and a communication network.

78. A computer program product as described in claim 75 wherein the instructions for requesting and receiving further comprise instructions for causing the programming transmission system to select the remote transmission source based upon a database profile of a programming library of digital program segments stored at the remote transmission source.

79. A computer program product as described in claim 78 further including instructions for causing the programming transmission system to update the programming library according to a set of rules governing the database profile which dictates the digital program segments to be stored, a location for storing the digital program segments, and a period of time for storage, and wherein the rules are based upon an aggregation of related user preference information of multiple users.

80. A computer program product as described in claim 62 wherein the instructions for accessing further including instructions for causing the programming transmission system to retrieve digital program segments from the Internet via a communication link between the programming transmission center and the Internet.

81. A computer program product as described in claim 62 wherein the instructions for accessing further including instructions for causing the programming transmission system to retrieve digital program segments from a private network via a communication link between the programming transmission center and the private network.

82. A computer program product as described in claim 62 wherein the programming transmission system transmits the digital program segments over a transmission medium selected from the group consisting of: terrestrial television broadcast, cable, satellite, fiber optic, microwave, radio, telephone, wireless telephone, and a communication network.

83. A computer program product as described in claim 82 wherein the communication network comprises the Internet.

84. A computer program product as described in claim 82 wherein the communication network comprises a private network.

85. A computer program product as described in claim 62 wherein the digital program segments comprise programming selected from the group consisting of: audio, video, multimedia, graphic image, animation, data, programming applications, and text.

86. A computer program product as described in claim 62 wherein the digital program segments comprise still frame pictures for transmission via a low bandwidth transmission medium.

87. A computer program product as described in claim 62 wherein the customized programming is transmitted to a plurality of users whose user preference information indicates common programming interests.

88. A computer program product as described in claim 70 further including instructions for causing the programming transmission system to receive the user's input or the user's responses to one or more interrogatories contained in the digital program segments at the programming transmission center via the backchannel communication link, whereby the particular digital program segments selected are further determined by the interactive programming system based upon user responses to the posited interrogatories.

89. A computer program product as described in claim 64 wherein the instructions for encoding further include instructions for encoding one or more data commands in one or more of the digital program segments, the data commands for instructing receiving equipment at a user's location to retrieve additional digital program segments from the Internet.

90. A computer program product as described in claim 65 wherein the instructions for encoding further include instructions for encoding one or more data commands in one or more of the digital program segments, the data commands for instructing receiving equipment at a user's location to retrieve additional digital program segments from the Internet.

91. A computer program product as described in claim 64 wherein the instructions for encoding further include instructions for encoding one or more data commands in one or more of the digital program segments, the data commands for instructing receiving equipment at a user's location to retrieve additional digital program segments from a private network.

92. A computer program product as described in claim 65 wherein the instructions for encoding further include instructions for encoding one or more data commands in one or more of the digital program segments, the data commands for instructing receiving equipment at a user's location to retrieve additional digital program segments from a private network.
